(19) United States
(12) Patent Application Publication
(10) Pub. No.: US 2023/0150617 A1
(43) Pub. Date: May 18, 2023

(54) WORKBOAT AND METHOD FOR OPERATING A WORKBOAT

(71) Applicant: DBFZ DEUTSCHES BIOMASSEFORSCHUNGSZENTRUM GEMEINNUETZIGE GMBH, LEIPZIG (DE)

(72) Inventors: MATHIAS STUR, LEIPZIG (DE); WALTER STINNER, TAUCHA (DE); BENGT VERWORNER, LEIPZIG (DE)

(73) Assignee: DBFZ DEUTSCHES BIOMASSEFORSCHUNGSZENTRUM GEMEINNUETZIGE GMBH, LEIPZIG (DE)

(21) Appl. No.: 17/986,911

(22) Filed: Nov. 15, 2022

(30) Foreign Application Priority Data
Nov. 16, 2021 (DE) 10 2021 129 802.4

(51) Int. Cl. B63B 35/00; B63B 3/00

(52) U.S. Cl. CPC B63B 35/00; B63B 3/00; B63B 2003/085

(57) ABSTRACT

A workboat includes at least two hulls, at least one work tool, a body, and at least one carrier frame which is fastened on the body, between a bow and a stern of the workboat. The at least one work tool is arranged on the at least one carrier frame. A range of movement of at least one of the at least one carrier frame and the at least one work tool, in a transverse direction of the workboat, is located centrally with respect to the workboat and between the at least two hulls which extend in a longitudinal direction. In an event of a position change during a work procedure of the at least one work tool, a position of a center of gravity of the workboat varies by at most 15% with respect to a boat length of the workboat.

### CROSS REFERENCE TO PRIOR APPLICATIONS

Priority is claimed to German Patent Application No. DE 10 2021 129 802.4, filed Nov. 16, 2021. The entire disclosure of said application is incorporated by reference herein.

### FIELD

The present invention relates to a workboat comprising at least two hulls, a body, and at least one work tool.

The present invention furthermore relates to a method for operating a workboat of this kind, in particular as a harvesting boat for harvesting aquatic plants.

### BACKGROUND

DE 10 2010 037 781 A1 describes a mowing collecting boat for aquatic plant clearance, comprising a collection and conveyor belt, and comprising a mower which is mounted on the bow side, and which comprises two hulls, arranged in parallel as a multi-hull boat, as a boat hull. The mower of the boat is also height adjustable. The mowing collecting boat also comprises receiving, collection, and conveyor belts.

Features in DE 10 2010 037 781 A1 are the combination of the height-adjustable U-shaped mower with receiving and transfer belts. This technical solution comprising a mower mounted on the bow side does not exploit the multi-hull design while simultaneously making use of the space between the hulls in order to maintain good positioning stability during the height-adjustment of the mower. The bow suspension of the work tool extends the overall boat, shifts the center of gravity forwards, and causes an increased swaying when the work tool is moved. This must be compensated by a sufficient size and mass of the boat with respect to the work tool. As a further consequence, the disadvantage of the increased size and of the increased mass, both with respect to the work performance and the associated reduced mobility and/or maneuverability, results.

A compact harvesting or mowing boat is described in DE 185 8798 U1, wherein the mower therein described is mechanically adjustable in terms of height, in particular by using a hand crank. The height-adjustment of the tool thereby has little influence on the center of gravity, but the combined reception of the harvest yield is possible only with increased technical effort.

### SUMMARY

An aspect of the present invention is to provide a workboat and a method for operating a workboat of this kind which overcome the disadvantages of the prior art. The workboat should have a technically simple design and to be usable in particular as a harvesting boat for the continuous harvesting of aquatic plants.

An additional aspect of the present invention is the temporary storage of the harvest yield, starting from the harvest yield being received in a virtually continuous manner and in a technically simple manner, and transferring the harvest yield at intervals to a downstream handling system, for example, for transport purposes, wherein the harvesting process should not thereby be interrupted.

In an embodiment, the present invention provides a workboat which includes at least two hulls, at least one work tool, a body, and at least one carrier frame which is fastened on the body, between a bow and a stern of the workboat. The at least one work tool is arranged on the at least one carrier frame. A range of movement of at least one of the at least one carrier frame and the at least one work tool, in a transverse direction of the workboat, is located centrally with respect to the workboat and between the at least two hulls which extend in a longitudinal direction. In an event of a position change during a work procedure of the at least one work tool, a position of a center of gravity of the workboat varies by at most 15% with respect to a boat length of the workboat.

### BRIEF DESCRIPTION OF THE DRAWINGS

The present invention is described in greater detail below on the basis of embodiments and of the drawings in which:

FIG. 1 is a schematic perspective view of an embodiment of a workboat 5;

FIG. 2 is a schematic perspective view of an embodiment of the hulls 2;

FIG. 3 is a schematic perspective view of an embodiment of a harvesting boat 6;

FIG. 4 is a schematic plan view of an example of use of a novel harvesting method N compared with a conventional harvesting method K;

FIG. 5 is a schematic perspective view of an example of use of a novel harvesting method N; and

FIG. 6 is a schematic plan view of an embodiment of a workboat 5 comprising the arrangement of a boat drive 3 between two hulls 2 which are arranged linearly in succession.

### DETAILED DESCRIPTION

A core concept of the present invention is that at least one carrier frame 4.4 is fastened on the body 1, between the bow and the stern, and at least one work tool 5.1 is arranged on a carrier frame 4.4, wherein the range of movement of the carrier frame 4.4 and/or at least one work tool 5.1 is located in the transverse direction centrally with respect to the workboat 5, between the at least two hulls 2 which extend in the longitudinal direction, and, in the event of position change during the work procedure of at least one work tool 5.1, the position of the center of gravity of the workboat 5 varies by at most 15% with respect to the boat length of the workboat 5.

Use is thus made of the advantages of the multi-hull design, in particular a compact and lightweight design of the workboat 5, in particular as a harvesting boat 6, with simultaneously high power in relation to the boat size during the harvesting process and the transfer of the harvest yield E.

According to the present invention, the arrangement of the range of movement between at least two hulls 2 causes the center of gravity of the workboat 5 on the central longitudinal axis in the transverse direction to be shifted in the longitudinal direction by at most 15%, with respect to the boat length, in the case of movement of the at least one work tool 5.1, in particular the harvesting tool 6.1, without additional ballasting measures being required.

This makes it possible for the tipping stability and listing resistance of the workboat 5 or the harvesting boat 6, respectively, to be virtually unimpaired in the event of a function-related height adjustment of the work tool 5.1 or of the harvesting tool 6.1.

In the range of movement of the carrier frame 4.4, the movement path of the carrier frame 4.4 extends in parallel with the longitudinal axis of the workboat 5 or harvesting boat 6. In this case, there is a vertical movement of the carrier frame 4.4 in parallel with the longitudinal axis of the workboat or harvesting boat 6, but a negligible horizontal movement of the carrier frame 4.4 relative to the water surface.

The movement path of the work tool 5.1, which extends in parallel with the longitudinal axis of the workboat or harvesting boat 6, is located in the range of movement of the variable operating work tool 5.1. There is in this case a substantially vertical movement of the work tool 5.1 in parallel with the longitudinal axis of the workboat or harvesting boat 6. The work tool 5.1 can in each case pivot horizontally out of the movement path of the carrier frame 4.4, for example, up to 50%, in both directions.

The entire boat size and the complete buoyancy can as a result be used to absorb the working load. The ratio of boat size to payload of the work tool 5.1 or of the harvesting tool 6.1, plus the working load, for example, the extracted harvest yield E, can thereby be significantly improved. This is not, however, to the detriment of the maneuverability and safety on bodies of water. These are improved because the more favorable center of gravity minimizes the tilting movements about the transverse axis of the workboat 5 or harvesting boat 6 in the event of a change in the working depth and in the excavation of the work tool 5.1 or harvesting tool 6.1. The stability against listing, for example, in the case of a swell on the body of water G, is minimized by the multi-hull design, as in the case of existing technical solutions. The specifications for listing resistance are met. Safety requirements according to current specifications, such as set forth in the IS-Code 2008 on intact instability, as contained in the written statement on the commercial use of pleasure craft of the Berufsgenossenschaft für Transport und Verkehrswirtschaft [professional association for transport and transport economy], are fulfilled.

At the same time, in particular in the case of use as a harvesting boat 6, the harvesting tool 6.1, the conveyor belt 4.1, and the range of movement between the hulls 2 are used for conveying and temporarily storing the harvest yield E.

The workboat 5 is not designed as a compact boat, but rather as a multi-hull boat. This has significant advantages. For example, in order to allow adjustment to different water depths, compared with solutions available hitherto, instead of being suspended directly on the bow, the harvesting tool 6.1, which is suspended on a joint 4.5 by a carrier frame 4.4, can be suspended significantly further to the rear, in particular between the hulls 2. Irrespective of the load state, this allows for a significantly more favorable center of gravity, a higher degree of structural stability, and a significantly smaller and more compact design at an identical payload of the structural parts, because the mass of the tool hitherto conventionally attached at the bow side must no longer be compensated by the overall boat size and possible ballasting in the stern.

The workboat 5 is therefore compact and positionally stable. Use is made of the advantages of the multi-hull design. The suspension of the work tool 5.1 between the hulls 2 shifts the center of gravity towards the center. A better ratio of performance and receiving capacity to length and size and better positional stability of the harvesting boat 6 are thereby achieved, in particular in the case of the harvesting and load-transfer process.

The workboat 5 is intended for a vehicle load capacity in the range of from approximately 50 kg to approximately 10 t. In this case, the workboat 5 has a length of from approximately 2 m to approximately 15 m, and a width of from approximately 1 m to approximately 5 m.

The novelty of the present workboat 5 is in particular found in the above boat properties. A modular concept, as a possible, very advantageous combination with further modules for transport and docking, is also made possible. A chain, with the docking being systematically matched to an efficient harvest, is thus made possible. This includes progressive material transport by barges 7.1 and at least one docking module 7.2 for material transfer to transport devices T, such as transport vehicles or transport containers, in each case on the basis of a common technical platform, for cost reduction, flexibility and simplification. Complex loading, problematic for the shore zone, using wheeled loaders, amphibious vehicles, etc., can be omitted, and the docking need not take place in highly used, and thus conflict-laden, regions of port-like infrastructure, as described in an embodiment. No comparable concept exists.

The workboat 5 can, for example, be operated manually, for example, in a partially or highly automated manner, and/or by remote control.

The partially or highly automated operation in particular includes the use of sensors and control with partially or fully automated actuation of all required actuators for boat coupling processes, a harvesting process, discharge or load-transfer processes, operation of the harvesting unit, maneuvering of the workboat 5, in the design as a harvesting boat 6, in order to simplify the boat operation.

“Highly automated” as used by the present invention means a completely automated operation with the possibility of a manual intervention, wherein known control elements are available for this purpose.

The remote-control operation includes the manual or partially or highly automated actuation of required actuators via a radio control unit, so that the transmitter, for example, from the shore, transmits radio signals to the receiver on the harvesting boat 6, or, in the opposite direction, as a transmitter from the harvesting boat 6 to further devices, such as a barge 7.1 or at least one docking module 7.2.

The workboat 5 or harvesting boat 6 can, for example, comprise at least one boat drive 3 and an operating unit 3.1, wherein the boat drive 3 can, for example, be driven by an electric motor. The boat drive 3 can alternatively be operated by a combustion engine.

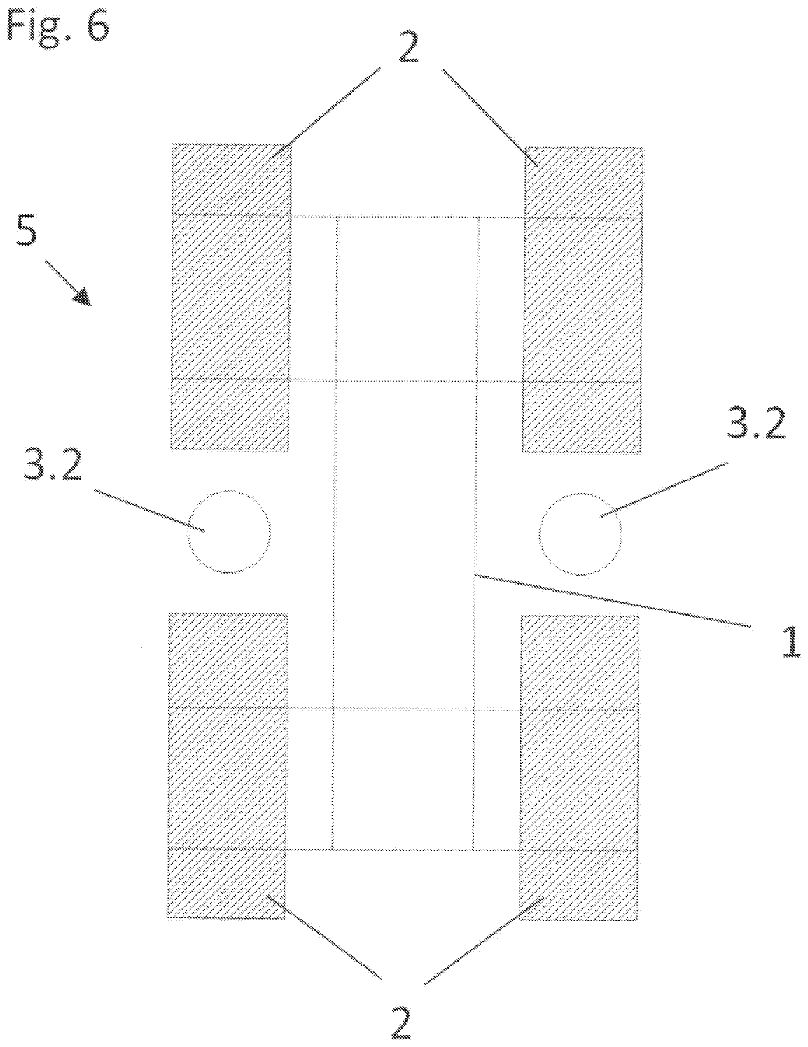

The operating unit 3.1 serves to actuate the boat drive 3, and thus to maneuver the workboat 5 or the harvesting boat 6 on a body of water G. A small harvesting boat design and continuous harvest with transfer on the body of water G, without significant intermediate buffering of the harvest yield E on the harvesting boat 6, results in better maneuverability at the same harvest performance compared with conventional harvesting boats having larger dimensions, even in the case of a hull-side drive. The central arrangement of the drive units 3.2 (see FIG. 6) makes it possible to further improve the high degree of maneuverability.

The workboat 5, in particular the harvesting boat 6, can, for example, comprise a control station, for example, having a seat 6.2. The seat 6.2 serves as a control point of the operating unit 3.1 for the operator on the harvesting boat 6.

The hull 2 can, for example, consist of at least one hollow body 2.3, and/or at least one pneumatically preloaded membrane air body 2.1, and/or at least one mechanically preloaded membrane folding body 2.2. The present invention also relates to a segmentation of a hollow, membrane air and/or membrane folding body. The arrangement of at least two hulls 2, for example, arranged in parallel, allows for the buoyancy required for the floating of the boat, as well as high positional stability in the body of water G.

If the harvesting boat 6 has more than two hulls 2, the harvesting tool 6.1 is arranged centrally therebetween.

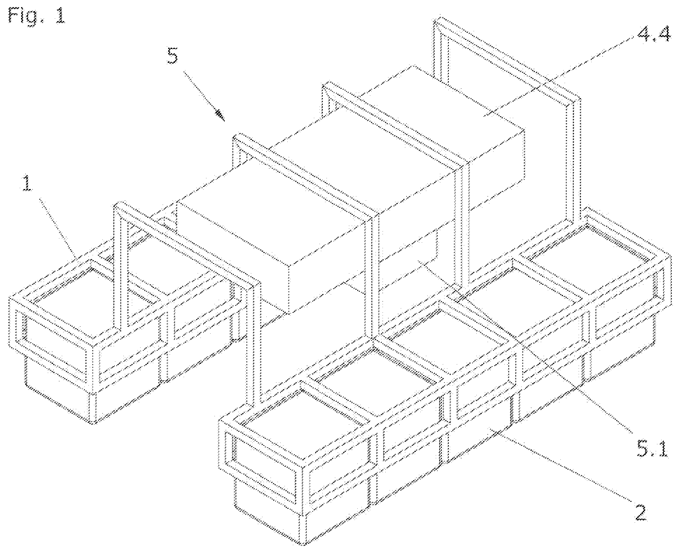

Within the meaning of the present invention, each hull 2 can be designed as a hull compound. Combinations of hulls 2 arranged side-by-side or one behind the other are possible in this case, as shown, for example, in FIGS. 1, 2 and 6.

The workboat 5 can, for example, be a harvesting boat 6, a sample collection boat, a boat for drilling applications, for removal of material and objects from bodies of water, a pipe-laying boat, or a boat comprising a suction and/or grab dredger, or a boat which serves at least as a floating platform for handling purposes within the meaning of water-management and water-based construction applications. Procedures such as drilling, clearing work above and/or in the body of water G and on the bed or on land, sample collection, laying or removal work are intended to be made possible thereby.

The workboat 5 can, for example, have at least one transfer unit 4 and serves to transfer transport goods T.

For example, the workboat 5 can be a harvesting boat 6, the work tool 5.1 can be a harvesting tool 6.1, the transfer unit 4 can comprise the carrier frame 4.4 and at least one conveyor belt 4.1 so that the conveyor belt 4.1 is carried by the carrier frame 4.4. In this case, both the harvesting tool 6.1 and at least one conveyor belt 4.1 of the transfer unit 4 and the harvest yield E stored temporarily on the conveyor belt 4.1 are arranged in the transverse direction centrally with respect to the workboat 5, between the at least two hulls 2 extending in the longitudinal direction or the inner hulls 2 extending in the longitudinal direction, wherein at least one conveyor belt 4.1 of the transfer unit 4 can, for example, be water-permeable.

The positioning of the work tool 5.1, in particular the harvesting tool 6.1 of the harvesting boat 6, between the hulls 2 can, for example, allow for a quiet and efficient operation of the workboat 5.

The carrier frame 4.4 of the harvesting boat 6 can, for example, be arranged at the stern side, on a joint 4.5 on the body 1, and thus be connected to the body 1 in a manner rotatable about the joint 4.5.

The pivot drive 4.3 can, for example, be connected to the carrier frame 4.4 and the body 1, in the sense of a positioning actuator. It is thus intended for an actuation of the pivot drive 4.3 to allow for a position change of the carrier frame 4.4, within the meaning of pivoting relative to the body 1 and rotatable about the joint 4.5.

The harvesting tool 6.1 can, for example, be arranged on the bow side, on the carrier frame 4.4, wherein the harvesting tool 6.1 is carried by the carrier frame 4.4, and the working height in particular of the cutting region of the harvesting tool 6.1 can be variably adjusted by pivoting the carrier frame 4.4. In this case, a range of 0.25 m above the surface of the body of water to 2 m below the surface of the body of water can, for example, be adjusted.

At least one connection element 4.2 of the transfer unit 4 can, for example, be arranged on the body 1. The connection element 4.2 is in this case designed for an accurately repeatable connection of the harvesting boat 6 to further watercraft such as barges 7.1, for example, using a catching device and self-retaining locking device. Robust load-transfer procedures in the case of adverse weather conditions on the body of water G are thereby, for example, made possible.

The harvesting boat 6 can, for example, comprise at least one sensor monitoring device for operation of the harvesting tool 6.1, which allows for a higher level of safety.

The harvesting boat 6 can, for example, comprise an intermediate buffer for the harvest yield E, wherein at least one conveyor belt 4.1 of the transfer unit 4 can, for example, serve as the intermediate buffer. An interruption of the harvest yield output occurs in the case of a changeover process of the barge 7.1 on the harvesting boat 6. The intermediate buffering of the harvest yield E on at least one conveyor belt 4.1 during the barge change briefly bridges the harvest yield output and allows for a continuous harvesting process of the harvest yield E.

If the harvesting boat 6 has two hulls 2, the conveyor belt 4.1 is arranged centrally therebetween.

If the harvesting boat 6 has more than two hulls 2, the conveyor belt 4.1 is arranged centrally between the two inner hulls 2.

In this case, the space between the two parallel hulls 2 is in particular used for suspension and as a range of movement for the variable operating work tool 5.1 or the harvesting tool 6.1 which works at a water depth of up to 2 m. The smaller design of the work tool 5.1 or harvesting tool 6.1 with respect to the work performance achieved, compared with the conventional technique, makes the workboat 5 or harvesting boat 6 more compact, shorter, and more maneuverable. This is in particular important in the frequently critical regions close to the bank, or of infrastructure (i.e., landing stages, docking points A, piers, bridge pillars and infrastructure for local recreation).

The conveyor belt 4.1 can, for example, be designed as an open conveyor belt 4.1 comprising, for example, plastics links, which reduces the overall mass of the workboat 5 or harvesting boat 6, as a lightweight construction measure, and via which water can also drain off.

Drainage of the harvest yield E can, for example, take place by draining off dripping water on a water-permeable conveyor belt 4.1.

Dripping water is the water from the body of water that remains behind on the aquatic plants W after harvesting, and which flows off due to storage of the harvested aquatic plants W outside of the body of water W.

An increase in the transport effectiveness with respect to the harvest yield E is achieved by a small water proportion of the harvest yield mass.

A gentle cutting technique is also intended to achieve the smallest possible number of leaking cuts, in particular aquatic plant sap, of the cut and recovered aquatic plants W. The emission of aquatic plant sap is thus reduced. The loss of the energy content of the harvest yield E with respect to a possible use as a substrate, for example, in a downstream biogas facility, is also reduced.

The harvesting boat 6 can, for example, comprise an exchangeable harvesting tool 6.1.

Different tools, for example, a bar mower, T-shaped mower, U-shaped mower or cylinder mower can thus be exchanged quickly and safely, and in a technically simple manner.

The workboat 5 or harvesting boat 6 can, for example, have a technically simple coupling system comprising at least one connection element 4.2, consisting of a catching device having a self-retaining locking device. An accurately repeatable connection between a harvesting boat 6 and further transport modules 7, such as a barge 7.1 or a docking module 7.2, is in this case intended to be made possible by at least one connection element 4.2. Robust load-transfer procedures, in particular in adverse weather conditions, on the body of water G are thus made possible so that the harvesting boat 6 can, for example, be used exclusively for harvesting, and the time-consuming transport of transport goods T, in particular harvest yield E, can be performed using at least one or correspondingly operating barges 7.1. This is intended to allow a virtually continuous flow of material, in particular for harvest yield E.

“Virtually continuous” as used in the present invention means a harvest by the harvesting boat 6 which is permanently possible, with simultaneous load-transfer of the harvest yield E at intervals to downstream receiving devices, for example, onto a barge 7.1 on the body of water G or onto a transport device T on land.

The harvesting process of aquatic plants W by the harvesting boat 6 takes place by using a harvesting tool 6.1, for example, a U-shaped mower, and the forwards movement of the harvesting boat 6 is achieved by a boat drive 3 on the body of water. Depending on the properties of the aquatic plants W, the forwards movement or the advance of the harvesting boat 6 is in this case matched to the working speed of the harvesting tool 6.1 in order to provide an efficient and eco-friendly harvest.

Typical harvesting tools adjusted to different aquatic plants W are used.

Measures for protecting the flora and fauna can, for example, be used, and at least one escape region for fauna exists, for example, in the region of the harvesting tool 6.1 and before transfer onto the conveyor belt 4.1. In particular taking into account the recommendations for a gentle and eco-friendly maintenance of bodies of water, aquatic animals that can swim, such as juvenile fish and crustaceans, water insects and amphibians, can thus escape, which animals are prompted to escape by the harvesting process. An escape region for an animal size of up to 100 mm is in this case provided.

The present invention further provides a method which comprises at least the method step of load-transfer of the harvest yield E from a harvesting boat 6 onto a transport module 7.

In this case, the harvest can, for example, take place using a harvesting tool 6.1. The receiving of the harvest yield E on the conveyor belt 4.1, the intermediate buffering on the conveyor belt 4.1, and the load-transfer of the harvest yield E via the conveyor belt 4.1 are in this case made possible (see embodiment 3). This allows for the harvest of aquatic plants W on the body of water G at a harvesting site, and the intermediate buffering of the harvest yield E on the conveyor belt 4.1. The autonomous load-transfer of harvest yield E on the body of water G, via the transfer unit 4 and the conveyor belt 4.1 of the harvesting boat 6, proceeding from the harvesting boat 6 onto a transfer point located outside of the harvesting boat 6, such as a transport module 7, is thus made possible.

The method can, for example, make possible at least the method step of an efficient load-transfer of the harvest yield E from a harvesting boat 6 via a coupling process using a catching device and self-retaining locking device onto a transport module 7, for example, a barge 7.1 or a docking module 7.2, and an autonomous load-transfer of the harvest yield E onto the barge 7.1 by the actuation of the conveyor belt 4.1. The barge 7.1 and the docking module 7.2 are in this case based on the same platform design as the harvesting boat 6.

The method step of an efficient and autonomous load-transfer of the harvest yield E from the harvesting boat 6 onto the barge 7.1 in this case reduces the required capacity for intermediate buffering on the harvesting boat 6. A smaller size, a more compact design, and a higher maneuverability of the harvesting boat 6 is thus achieved. The range of use of the harvesting boat 6 with respect to the size of the body of water is thus expanded. That is to say, that an efficient harvest is possible, both in the case of small and large bodies of water G, using the same harvesting boat 6.

The method can, for example, comprise at least the method step of load-transfer of the harvest yield E from a harvesting boat 6 to a transfer point which is located outside of the harvesting boat 6, for example, on a barge 7.1 and/or from this onto at least one docking module 7.2.

This makes possible a harvesting process in which the work is divided, the process comprising a harvesting boat 6, a barge 7.1, and a docking module 7.2. The interaction of the harvesting boat 6, barge 7.1, and at least one docking module 7.2 can be achieved by method steps executed in parallel or simultaneously.

A continuous harvesting process and a batchwise discharge or transfer of the harvest yield E can, for example, be carried out.

On account of the efficiency of the automated, accurately repeatable load-transfer process, a small capacity of the intermediate buffering on the harvesting boat 6 also does not reduce the efficiency of the overall harvesting method. A compact design of the harvesting boat 6 with high maneuverability and lower investment in production of the harvesting boat 6 is thereby made possible.

The method can, for example, be performed using at least one barge 7.1 and at least one docking module 7.2. Cost reductions are thereby made possible because, in the harvest chain in which work is divided, having a quick and simple load-transfer, the harvesting boat 6, which is the machine which is the costliest both in terms of investment and in terms of operation, is concentrated on the highest-value tasks of the harvesting process. In terms of operation, the transport processes can be designed to be far more easily remote-controllable or partially or highly automated, or can be operated by less qualified staff.

In conjunction with at least one barge 7.1 and at least one docking module 7.2, and the method step of autonomous and efficient load-transfer, saving on travel times for the harvesting boat 6 and saving on loading work, for example, using a wheeled loader or excavator in the shore region U is, for example, made possible.

A coupling process using a catching device and self-retaining locking device, between the workboat 5, in particular the harvesting boat 6, and the following transport module 7, can, for example, take place. These largely automatable coupling processes and the method chain makes possible savings on working time due to the remote controllability or partially or highly automated operation of the transport and docking.

In conjunction with the at least one barge 7.1 and at least one docking module 7.2, the decoupling of work tasks can, for example, be made possible, which leads to cost savings and an efficiency increase in the method compared with the prior art.

A simple modular design, using easily available standard parts and components in a short parts list can, for example, be provided which consequently allows for a cost-effective production, as well as for maintenance and a supply of replacement parts, and thus simultaneously a high degree of operating safety which can be organized in a cost-effective manner.

Further features, properties and advantages of the present invention can be found in the following description of embodiments under reference to FIGS. 1 to 6.

FIG. 1 is a schematic perspective view of an embodiment of a workboat 5. The workboat 5 consists of at least two hulls 2; two hulls 2 are relevant and shown in FIG. 1 along with a body 1, and a work tool 5.1.

The carrier frame 4.4 is fastened to the body 1, between the bow and stern. The work tool 5.1 is arranged on a carrier frame 4.4, wherein the range of movement of the carrier frame 4.4 and/or at least one work tool 5.1 is located in the transverse direction centrally with respect to the workboat 5, between the at least two hulls 2 which extend in the longitudinal direction. The position of the center of gravity of the workboat 5 varies in the case of a position change during the work process of the work tool 5.1 by at most around 15%, with respect to the boat length of the workboat 5. The body 1 forms the carrying base of the workboat 5. Two hulls 2, arranged in parallel, are fastened on the body 1. The workboat 5 achieves floating ability and positional stability as a result of the buoyancy of the two hulls 2 as floating members in the body of water G. The work tool 5.1 is arranged on the carrier frame 4.4 and is carried thereby. The carrier frame 4.4 and the work tool 5.1 are arranged between the two hulls 2. The central arrangement of the carrier frame 4.4 comprising the work tool 5.1 achieves a stable position of the workboat 5 during use of the work tool 5.1 and in the case of working loads which may occur. The workboat 5 has a clear height of approximately 2 m, a clear length of approximately 4 m, and a clear width of approximately 2 m.

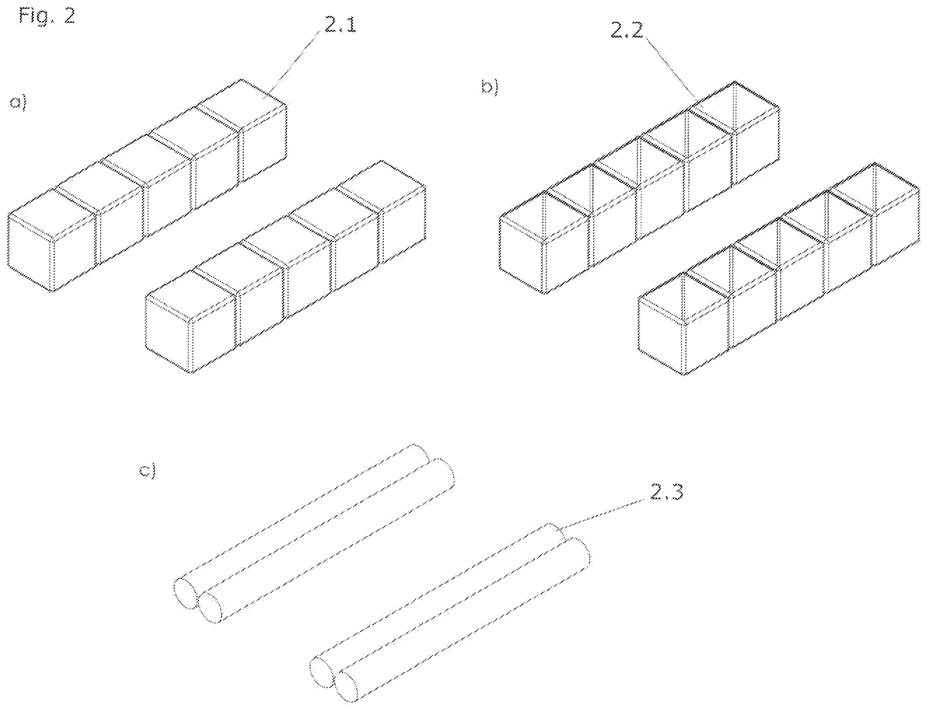

FIG. 2 is a schematic perspective view of three embodiments of the hulls 2. Each hull 2 has a clear length of approximately 4 m. A hull 2 should in this case be formed at least of:
a) one or more, in FIG. 2a), for example, five, pneumatically preloaded membrane air bodies 2.1, which are identical in design and cuboid, and are arranged in series, and/or
b) one or more, in FIG. 2b), for example, five, mechanically preloaded membrane folding bodies 2.2, which are identical in design and cuboid, and are arranged in series, and/or
c) one or more dimensionally stable hollow bodies 2.3, for example, designed as closed cylinders.

These embodiments allow for a simple mounting on and dismantling from the body 1, and transport of the hulls 2 in transport-friendly dimensions.

The pneumatically preloaded membrane air bodies 2.1, arranged, for example, in series, consist, for example, of a gastight and watertight, weather-resistant, flexible membrane, are designed to be closed, and are filled, for example, with air, wherein the hollow membrane air body 2.1 is acted on, for example, with a relative excess pressure with respect to the provided ambient pressure in order to provide an accurately repeatable shaping. The membrane air bodies 2.1 can be dismantled, relaxed, and stored in a space-saving manner for transport purposes.

The mechanically preloaded membrane folding bodies 2.2, arranged, for example, in series, consist, for example, of a watertight, weather-resistant and flexible membrane. These are designed to be open at the top, or so that they can be closed, in a manner protected against spray water, in order to prevent water entry, and are preloaded by clamping elements (not shown in FIG. 2), such as hingedly mounted struts, clasps or clamps, in order to provide an accurately repeatable shaping. The membrane folding bodies 2.2 can be dismantled, relaxed, and stored in a space-saving manner for transport purposes.

The hollow bodies 2.3 can, for example, consist of a dimensionally stable, watertight and impact-resistant material, for example, a plastics material. These are designed to be closed and/or closable to prevent water entry.

The mentioned embodiments of the hulls 2, such as the membrane air body 2.1, the membrane folding body 2.2, and the hollow body 2.3, are in each case detachably interconnected, and can alternatively be designed as solid bodies comprising floatable material.

The above descriptions according to FIG. 2 relate, within the meaning of the present invention, to embodiments of the present invention having two or more than two hulls 2.

A possible segmentation of the hulls 2 leads to an increase in the safety level by creating a means for prevention of sinking in the event of damage to one hull 2.

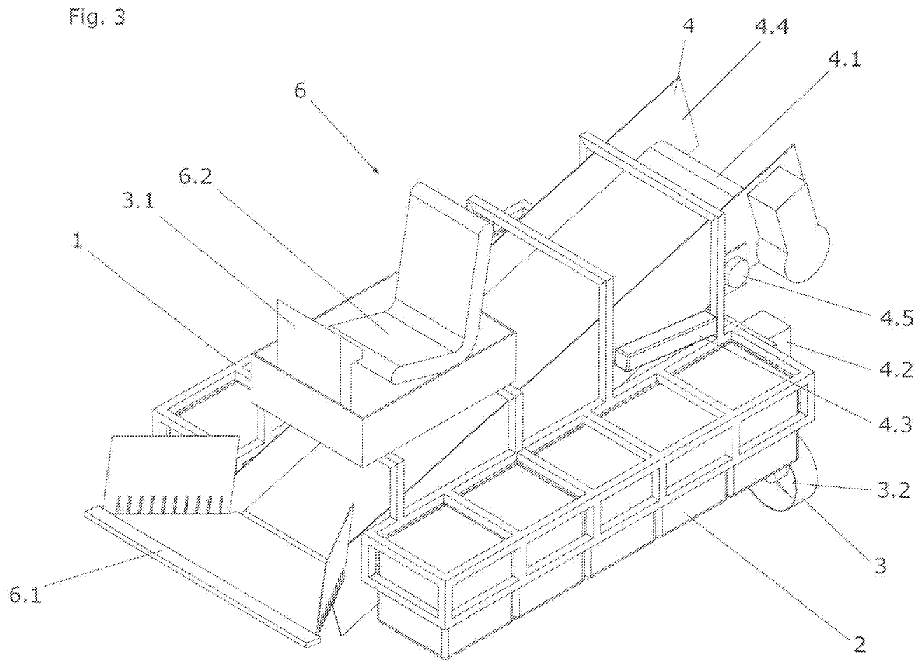

FIG. 3 is a schematic perspective view of an embodiment of a harvesting boat 6.

The carrier frame 4.4 is fastened to the body 1, between the bow and stern. The work tool 5.1 is arranged on a carrier frame 4.4, wherein the range of movement of the carrier frame 4.4 and/or at least one work tool 5.1 is located in the transverse direction centrally with respect to the harvesting boat 6, between the at least two hulls 2 which extend in the longitudinal direction. The position of the center of gravity of the harvesting boat 6 varies in the case of a position change during the work process of the work tool 5.1 by at most around 15%, with respect to the boat length of the harvesting boat 6.

The harvesting boat 6 has a clear height of 2.5 m, a clear length of 5 m, and a clear width of 2 m. It consists of two hulls 2, a body 1, a harvesting tool 6.1, and a transfer unit 4. The body 1 forms the carrying base of the workboat 5. Two hulls 2, arranged in parallel, are fastened on the body 1. The harvesting boat 6 achieves its floating ability and positional stability as a result of the buoyancy of the two hulls 2 as floating members in the body of water G. The multi-hull design, for example, the two-hull design, improves the positional stability compared with the single-hull design. The transfer unit 4 is carried by the body 1. The harvesting tool 6.1 is arranged on the carrier frame 4.4 of the transfer unit 4. The transfer unit 4 and the harvesting tool 6.1 are arranged between the two hulls 2.

The harvesting tool 6.1 serves for harvesting aquatic plants W, and is designed for example, as a sickle bar or U-shaped mower.

The carrier frame 4.4 is arranged between the two hulls 2 at the stern side, on a joint 4.5 on the body 1, and is connected to the body 1 in a manner rotatable about the joint 4.5.

The conveyor belt 4.1 is arranged on the carrier frame 4.4 and is carried by the carrier frame 4.4.

The pivot drive 4.3 is connected to the carrier frame 4.4 and the body 1, in the sense of a positioning actuator. It is intended for an actuation of the pivot drive 4.3 to allow for a position change in the sense of a pivoting of the carrier frame 4.4 relative to the body 1 and a rotation about the joint 4.5.

The harvesting tool 6.1 is arranged on the bow side, on the carrier frame 4.4, wherein the harvesting tool 6.1 is carried by the carrier frame 4.4, and the working height thereof can be set variably, in the range of from 0.25 m above the surface of the body of water to 2 m below the surface of the body of water, via the pivot-like position change of the carrier frame 4.4. The advantage of the pivot movement relative to a linearly vertical height adjustment of the harvesting tool 6.1 is in the combination of the height adjustability of the harvesting tool 6.1, for adjustment to different harvesting depths, with the simultaneous receiving of harvest yield on the transfer unit 4, in particular on the conveyor belt 4.1, as well as with the balancing of the center of gravity.

The connection element 4.2 of the transfer unit 4 is arranged on the body 1. The connection element 4.2 is in this case designed for an accurately repeatable connection of the harvesting boat 6 to further watercraft such as a barge 7.1, for example, in a partially or fully automated manner using a catching device and a self-retaining locking device. Robust load-transfer procedures, for example, in the case of adverse weather conditions on the body of water G, are thereby made possible. This in particular applies if the harvesting boat 6 is used primarily for harvesting aquatic plants W and the time-consuming transport can be achieved using barges 7.1.

The harvesting boat 6 comprises at least one sensor monitoring device (which is not shown in FIG. 3) which serves, for example, in the harvesting process and in the operation of the harvesting boat 6.1, to protect the harvesting tool 6.1 against damage by foreign bodies, or to prevent collisions with obstacles. This is intended to provide improved safety for preventing accidents, and a robust, damage-free and fault-free harvesting process.

The harvesting boat 6 comprises at least one boat drive 3 and an operating unit 3.1, wherein the boat drive 3 is driven by an electric motor. The operating unit 3.1 serves to actuate the boat drive 3 and thus to maneuver the harvesting boat 6 in the body of water.

The electric boat drive 3 comprises two drive units 3.2, arranged in parallel, and an operating unit 3.1.

The hull 2 is designed as a pneumatically preloaded membrane air body 2.1 for generating the buoyancy in the body of water G.

The arrangement of the carrier frame 4.4 between the hulls 2 allows for a quiet and efficient operation of the harvesting boat 6 during use of the harvesting tool 6.1.

The conveyor belt 4.1 is designed as an open module belt, for example, a plastics link belt. The conveyor belt 4.1 having a lightweight design reduces the overall mass of the harvesting boat 6 and allows for drainage of the harvest yield E by draining off dripping water via the water permeable conveyor belt 4.1.

The harvesting boat 6 comprises a seat 6.2. The seat 6.2 serves as a control point of the operating unit 3.1 for the operator on the harvesting boat 6.

The harvesting boat 6 can be operated manually, or alternatively can, for example, be operated in a partially or highly automated manner and/or in a remote-controlled manner (not shown in FIG. 3).

An escape region for fauna (not shown in FIG. 3) exists, in particular for aquatic animals that can swim, for example, juvenile fish and crustaceans, aquatic insects, and amphibians, in particular in the region of the harvesting tool 6.1 and before the transfer onto the conveyor belt 4.1, so that aquatic animals that can swim are prompted to escape and can escape.

The method for operating the harvesting boat 6 according to FIG. 3 is made up at least of the work steps of harvesting, intermediate buffering, and load-transfer.

The harvesting process takes place by the maneuvering, in particular the forward travel, of the harvesting boat 6 at the harvesting site via the boat drive 3 and the operating unit 3.1, and by the use of the harvesting tool 6.1 in the body of water G. The operation is in this case performed manually, in a partially or highly automated manner, or in a remote-controlled manner. The aquatic plants W are separated by the harvesting tool 6.1, in particular in the cutting region of the cutting unit, and gathered out of the body of water G, by the conveyor belt 4.1 downstream of the harvesting tool 6.1, as harvest yield E. The working height of the harvesting tool 6.1 can in this case be adjusted vertically in a variable manner by actuating the pivot drive 4.3, and the associated pivot movement of the carrier frame 4.4. After the receiving of the harvest yield E on the conveyor belt 4.1, the harvest yield E is temporarily stored on the conveyor belt 4.1. The harvest yield E is subsequently transferred by the conveyor belt 4.1 onto a downstream device, such as a barge 7.1, wherein in this case the barge 7.1 is connected to the harvesting boat 6 in an accurately repeatable and robust manner, via at least one connection element 4.2.

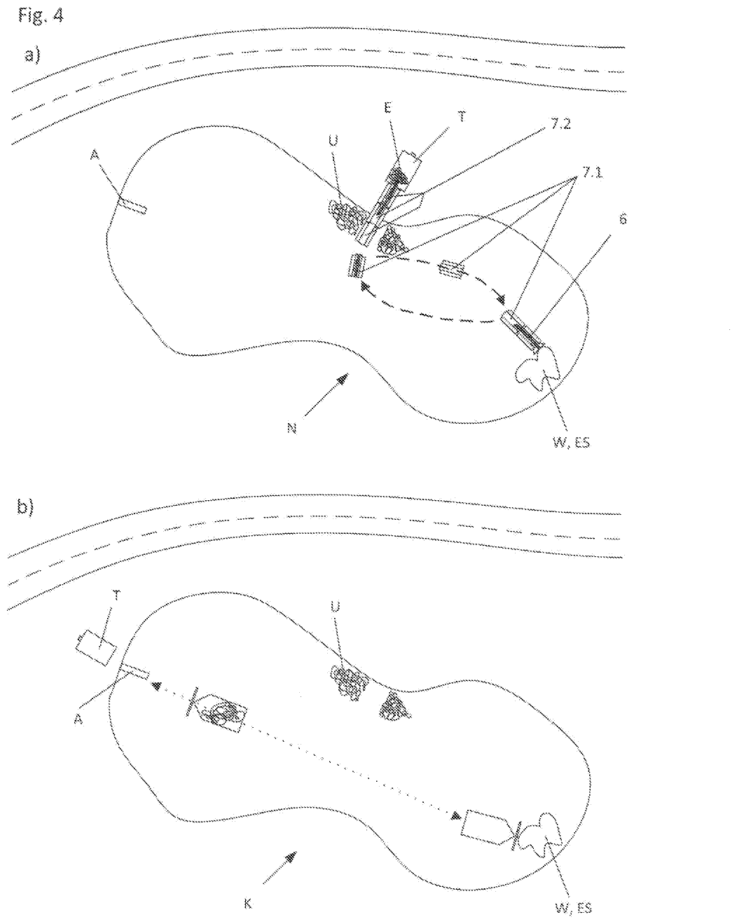

FIG. 4 is a schematic plan view of an example of use of a novel harvesting method N, see a), compared with a conventional harvesting method K, see b), wherein the harvesting boat 6 is located permanently at the harvesting site ES during the harvesting process, and carries out the harvesting process of aquatic plants W, for example, permanently. An autonomous load-transfer, at intervals, of the harvest yield E temporarily stored on the harvesting boat 6 onto one of three correspondingly operating and alternating downstream barges 7.1 for transporting away the harvest yield E, takes place simultaneously therewith. The independent load-transfer takes place via the actuation of the conveyor belt 4.1, wherein the harvest yield E located on the conveyor belt 4.1 is conveyed to the discharge region and discharged. No further technical assistance acting from the outside, e.g., in the form of a gripper arm, for discharging the harvest yield E, is in this case required. The load-transfer interval is determined temporally by the load-transfer process of the harvest yield E from the harvesting boat 6 onto the coupled barge 7.1, the uncoupling process of the laden barge 7.1 from the harvesting boat 6, and by the coupling process of the next following empty barge 7.2 onto the harvesting boat 6. The coupling and uncoupling process is achieved by the connection elements 4.2 using a catching device and a self-retaining locking device, which are arranged at the end face, on the bow and stern of the transport modules 7 involved in each case. The transportation of the harvest yield E away by the barge 7.1 takes place at end the docking module 7.2, on the water side, of a conveying path. The conveying path consists of three docking modules 7.2 that are arranged in succession and coupled, wherein at least the last docking module 7.2 in the conveying direction is positioned firmly on the bed of the shore region U which is difficult to access. An accurately repeatable coupling process between the laden barge 7.1 and the end docking module 7.2 on the water side, and an autonomous load-transfer of the harvest yield E from the laden barge 7.1, by the actuation of the conveyor belt 4.1 of the barge 7.1, onto the end docking module 7.2 on the water side, takes place. The conveying of the harvest yield E, to be conveyed, into a downstream transport device T, is achieved by the continuous operation of the conveyor belts 4.1 of the three docking modules 7.2 arranged in series and scaled relative to one another, in the sense of a conveying path. A bulk tipper container, trailer or lorry is in this case in particular used, which can be erected in the region that is easily accessible and load bearing with respect to the substrate, in the close proximity of the shore region U which is difficult to access or has poor load-bearing ability. No complex measures for providing access to the shore region U or to the load-transfer point are therefore required. No additional loading technology, such as a wheeled loader, excavator or crane, is required. For transporting the harvest yield E, vehicles, such as amphibious vehicles, do not travel over the shore region U, which corresponds to an eco-friendly application. A conventional harvesting method K is also shown in FIG. 4, under b). The conventional harvesting method K uses conventional harvesting boat, which is larger than the harvesting boat 6 of the present invention, which moves, empty, from the docking point A to the harvesting site ES and harvests the aquatic plants W. The harvest yield E is received until the storage capacity of the harvesting boat of the conventional harvesting method K is reached. Subsequently, using the larger conventional harvesting boat, the harvest yield E is transported away to a docking point A having a fixedly installed infrastructure, for example, a jetty suitable for this use. Depending on the technical equipment of the harvesting boat of the conventional harvesting method K, the load of the harvest yield E is transferred autonomously or with further technical support at the docking point A, and conveyed into a transport device T. The path of the conventional harvesting method K is shown by a dotted line, and the path of the novel harvesting method N is shown by a dashed line. The path of the conventional harvesting method K is longer than the path of the novel harvesting method N because the conventional harvesting method K uses docking points A comprising fixedly installed infrastructure. In the conventional technique, additional transport and loading techniques, such as amphibious vehicles, wheeled loaders, excavators and/or grabbers, must be used. The shore-protecting properties of the docking module 7.2 allow for a freer selection of the site for docking, in particular close to the harvesting site ES. Short travel paths for the barges 7.1 between the docking module 7.2 and the harvesting site ES, and thus efficient and time- and cost-saving harvesting chains, are thus possible. Associated therewith, the docking point A for erecting the transport device T can be selected in a more variable manner. Conflicts of use with other purposes, such as tourism, around the fixedly installed docking points A, such as jetties, can therefore be prevented.

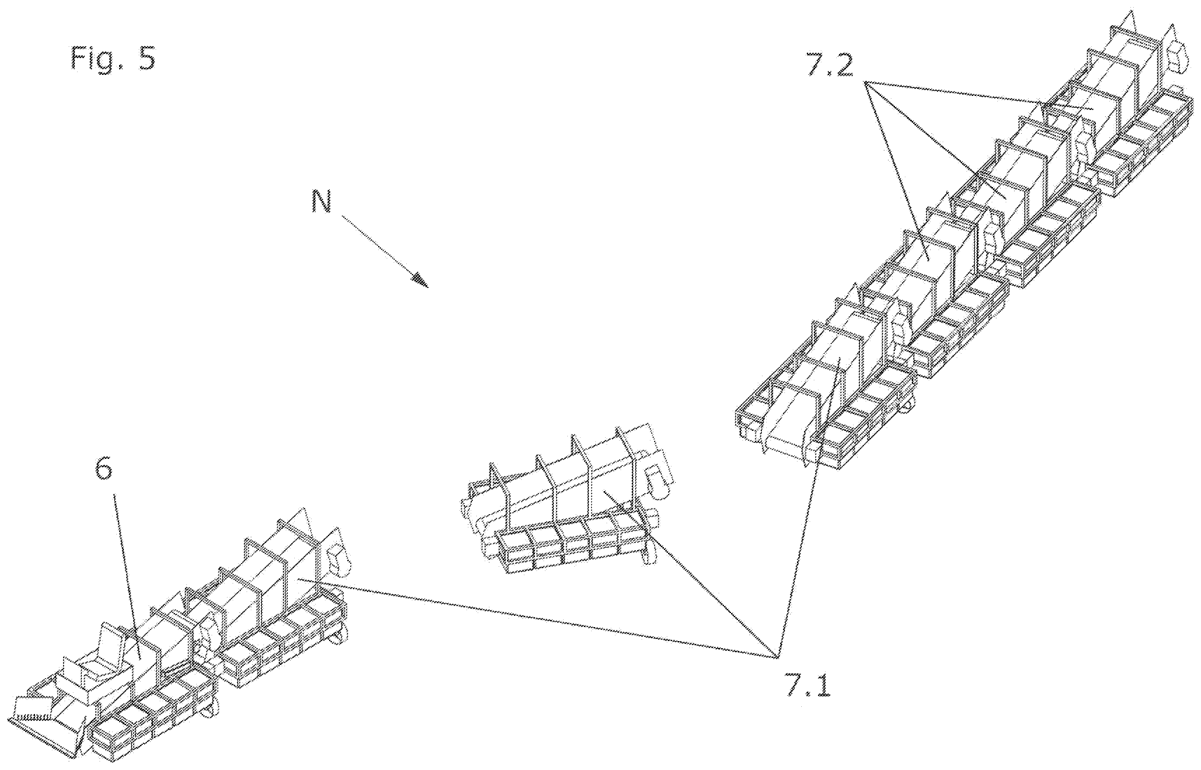

FIG. 5 is a schematic perspective view of an example of use of a novel harvesting method N. FIG. 5 shows a harvesting boat 6, three barges 7.1, and three docking modules 7.2, as a conveying path. This shows the load-transfer process of the harvest yield E from the harvesting boat 6 onto the coupled barge 7.1, the transfer of the harvest yield E by the loaded, freely floating barge 7.1, and the correspondingly operating barge 7.1 coupled to the end docking module 7.2 of the conveying path on the water side, as well as the successively scaled arrangement of the docking modules 7.2 in the sense of a conveying path according to FIG. 4. The number of docking modules 7.2 makes it possible for the conveying path from the body of water G to the transport device T can be variably adjusted to the respective local conditions of the application.

FIG. 6 is a schematic plan view of an embodiment of a workboat 5 comprising the arrangement of a boat drive 3 between two hulls 2 which are arranged linearly in succession. A body 1, two drive units 3.2, and four hulls 2 are shown in this case. The design is symmetrical, in the longitudinal direction along the long boat edge. A hull 2, as a hull compound structure consisting of two floating members in a row and in succession in the longitudinal direction, and a drive unit 3.2 between the two floating members of the hull 2, are arranged on each side of the workboat 5. In the floating state of the workboat 5 on the body of water G, the two drive units 3.2 are located under the water surface and are completely submerged. The arrangement of the two drive units 3.2, in each case between the two floating members of the hull 2 arranged in succession in the longitudinal direction, is intended to provide good maneuverability of the workboat 5 in a small range of movement.

The present invention is not limited to embodiments described herein; reference should be had to the appended claims.

### List of Reference Characters

1 Body

2 Hull

2.1 Membrane air body

2.2 Membrane folding body

2.3 Hollow body

3 Boat drive

3.1 Operating unit

3.2 Drive unit

4 Transfer unit

4.1 Conveyor belt

4.2 Connection element

4.3 Pivot drive

4.4 Carrier frame

4.5 Joint

5 Workboat

5.1 Work tool

6 Harvesting boat

6.1 Harvesting tool

6.2 Seat

7 Transport module

7.1 Barge

7.2 Docking module

A Docking point

E Harvest yield

ES Harvesting site

G Body of water

K Conventional harvesting method

N Novel harvesting method

T Transport device

TG Transport goods

U Shore region

W Aquatic plants

What is claimed is:

1-15. (canceled)

16. A workboat comprising:
at least two hulls;
at least one work tool;
a body; and
at least one carrier frame which is fastened on the body, between a bow and a stern of the workboat, the at least one work tool being arranged on the at least one carrier frame,
wherein,
a range of movement of at least one of the at least one carrier frame and the at least one work tool, in a transverse direction of the workboat, is located centrally with respect to the workboat and between the at least two hulls which extend in a longitudinal direction, and,
in an event of a position change during a work procedure of the at least one work tool, a position of a center of gravity of the workboat varies by at most 15% with respect to a boat length of the workboat.

17. The workboat as recited in claim 16, wherein,
the at least one carrier frame comprises a joint which is arranged rigidly relative to the body between the bow and the stern of the workboat, an axis of rotation of the joint extending in the transverse direction of the workboat,
the at least one carrier frame is configured to rotate relative to the joint,
a range of movement of the at least one carrier frame extends in a parallel course of the at least one carrier frame with respect to a vertically and longitudinally extending geometrical boat center plane, and
a movement of the at least one carrier frame together with the at least one work tool is a rotating movement in a rotational angle range of up to at most 180° with respect to the work tool relative to the body.

18. The workboat as recited in claim 16, wherein,
the at least one carrier frame comprises at least two joints which are each rigidly connected to the body between the bow and the stern of the workboat, the axes of rotation of the at least two joints extending in the transverse direction of the workboat as a coupling mechanism,
the at least one carrier frame is configured to rotate relative to the at least two joints, and
a range of movement of the at least one carrier frame extends in a parallel course of the at least one carrier frame with respect to a vertically and longitudinally extending geometrical boat center plane.

19. The workboat as recited in claim 16, wherein the workboat is configured to be at least one of operated manually, operated in a partially automated manner, operated in a highly automated manner, and operated by a remote control.

20. The workboat as recited in claim 16, further comprising:
at least one boat drive.

21. The workboat as recited in claim 20, wherein the at least one boat drive is driven by an electric motor and comprises a drive unit which is arranged at a stern side of the workboat or centrally with respect to the workboat.

22. The workboat as recited in claim 20, wherein the workboat is a harvesting boat.

23. The workboat as recited in claim 16, wherein each of the at least two hulls consist of at least one hollow body, at least one pneumatically preloaded membrane air body, and at least one mechanically preloaded membrane folding body.

24. The workboat as recited in claim 16, wherein the workboat is a sample collection boat, a boat for drilling applications, a pipe-laying boat, a boat comprising at least one of a suction and a grab dredger, and a boat which serves at least as a floating platform for a handling purpose for a water-management and a water-based construction application.

25. The workboat as recited in claim 16, wherein the workboat further comprises:
at least one transfer unit.

26. The workboat as recited in claim 25, wherein,
the workboat is a harvesting boat and the at least one work tool is a harvesting tool,
the at least one transfer unit comprises the at least one carrier frame and at least one conveyor belt, and
both the harvesting tool, the at least one conveyor belt of the at least one transfer unit, and a harvest yield which is stored temporarily on the at least one conveyor belt, are arranged, in the transverse direction of the workboat, centrally with respect to the workboat, between the at least two hulls extending in the longitudinal direction or between the at least two hulls which are arranged innermost extending in the longitudinal direction.

27. The workboat as recited in claim 26, wherein the at least one conveyor belt of the transfer unit is water permeable.

28. The workboat as recited in claim 26, wherein the harvesting boat comprises an intermediate buffer for the harvest yield.

29. The workboat as recited in claim 28, wherein the at least one conveyor belt serves as the intermediate buffer for the harvest yield.

30. The workboat as recited in claim 26, further comprising:
a coupling system comprising at least one connection element, the at least one connection element consisting of a catching device which comprises a self-retaining locking device.

31. A method of operating the workboat as recited in claim 16, the method comprising:
harvesting aquatic plants;
intermediately buffering; and
transferring a load,
wherein
the load is a harvest yield of the aquatic plants,
the workboat is a harvesting boat, and
the transferring of the load is a transfer of the harvest yield from the harvesting boat onto a transport module.

32. The method as recited in claim 31, wherein the method provides for an efficient and autonomous load-transfer of the harvest yield from the harvesting boat onto the transport module, and
the method further comprises:
transferring the harvest yield to a transport device which is positioned on land.

33. The method as recited in claim 32, wherein the efficient and autonomous load-transfer of the harvest yield reduces a required capacity for the intermediately buffering of the harvesting boat.

34. The method as recited in claim 31, wherein,
the transport module is a barge, a docking module, or a plurality of docking modules which are arranged in series one behind the other as a conveying path, and
the barge, the docking module, and each of the plurality of docking modules are based on a same platform design as the harvesting boat.

35. The method as recited in claim 31, further comprising:
coupling the harvesting boat to the transport module via a catching device and a self-retaining locking device.
